(19) United States
(12) Patent Application Publication
(10) Pub. No.: US 2018/0200032 A1
(43) Pub. Date: Jul. 19, 2018

(54) GINGIVAL RETRACTION CORD USING MICROFIBER

(71) Applicant: SureDent Corporation, Seongnam-si (KR)

(72) Inventor: Hojin BAE, Seongnam-si (KR)

(21) Appl. No.: 15/870,893

(22) Filed: Jan. 13, 2018

(30) Foreign Application Priority Data
Jan. 16, 2017 (KR) 10-2017-0007215
Mar. 2, 2017 (KR) 10-2017-0026973

(51) Int. Cl. A61C 9/00

(52) U.S. Cl. CPC A61C 9/0033

(57) ABSTRACT

A gingival retraction cord using microfiber includes a microfiber cord, which is knitted with a plurality of microfiber strands, of 83 to 95 wt %, a dye of 0.01 to 0.10 wt % for dyeing the microfiber cord, and hemostatic agent of 4.99˜16.99 wt % which is soaked into the microfiber cord. A thickness of the microfiber cord is 0.45 to 1.35 mm. The microfine cord is classified into a green microfiber cord, a brown microfiber cord, a purple microfiber cord, a blue microfiber cord, and an orange microfiber cord, depending on thicknesses of the microfiber cords, and the microfiber cords are dyed by using dyes.

### CROSS-REFERENCE TO RELATED APPLICATION

This application claims priority to and the benefit of Korean Patent Application No. 10-2017-0007215 filed on Jan. 16, 2017 and Korean Patent Application No. 10-2017-0026973 filed on Mar. 2, 2017, the entire contents of which are incorporated by reference herein.

### TECHNICAL FIELD

The present invention relates to a gingival retraction cord using microfiber, and more particularly, to a gingival retraction cord using improved microfiber which is almost free of lint and hemostatic agent penetrates well and by which a thickness of a dental cord can be easily distinguished.

### BACKGROUND

In general, a typical method for contraction and hemostasis of a gingival tissue prior to taking impression of a tooth which is prepared to form a crown or a bridge, is to mechanically pack a dental gingival retraction cord (hereinafter, referred to as a dental cord) with a short length in which astringent agent is saturated around a base of the tooth so as to expand a gingival sulcus space with respect to the base of the tooth.

The dental cord is used as a dental impression pretreatment material, that is, a gingival suture used for retracting the gingiva prior to impression, is used for effective gingival displacement, is placed on the gingival fissure for a period of time when the impression is obtained to make the prosthesis, thereby, being used to expose a margin of an abutment teeth by contracting the gingival tissue.

The dental cord uses hemostasis and gingival contraction (convergence) effects of the gingival fissure to do hemostasis of blood remaining in the gingival fissures in the mouth and reduce moisture of saliva and tissue fluid, and physically exposes a cervical margin through opening of the gingival fissure.

In addition, it is possible to accurately reproduce a margin of a removed cervical portion located at the open gingival fissure thereby capable of producing an excellent model for manufacturing a dental prosthesis, to accurately charge a direct restoration located at a cervical region, and to prevent a dental impression material and a restoration of the cervical region from being affected by hardening while obtaining the impression and filling the restoration.

The dental cord is used to create a clean gingival sulcus and to secure the view of a practitioner, and is used when a direct restoration (amalgam, composite resin, GI restoration, cement, temporary filler) of a natural tooth is charged.

In addition, the dental cord is used for obtaining impression for an indirect restoration (inlay, onlay, electric tube) of a natural tooth, and is used for abutment insertion of implants and to inhibit bleeding of the gingival fissure for the manufacturing of final prosthesis of the implants.

There is a method of manufacturing a gingival retraction cord using a cotton yarn which is disclosed in Korean Patent No. 10-1237436 (registered on Feb. 20, 2013), as an example of a dental cord of related art having the above-mentioned purpose.

However, since the dental cord manufactured by the above-described method of related art for manufacturing the gingival retraction cord using a cotton yarn uses the cotton yarn, many lints are produced during the manufacture of the dental cord or during treatment in a dentistry.

Referring to FIG. 1 attached to the ‘method for manufacturing a gingival retraction cord using a cotton yarn’ of the above-mentioned patent, it can be seen that a cotton yarn cord has lots of fine hairs (or lint).

In order to solve the problem, a singeing process was performed to fabricate a cotton yarn code as illustrated in FIG. 2, but it can be seen that an improved cotton yarn code still has lint as illustrated in FIG. 2.

The improved cotton yarn cord has also limitation in that it does not cause lint due to characteristics of the cotton yarn, and if a dental cord having lots of lints is used, a foreign material sensation can be generated in the mouth of a patient.

In addition, hemostatic agent does not penetrate the cotton yarn well because of being thick, and thereby, hemostatic effects are reduced.

In addition, dental cords having different thicknesses have to be used according to tooth conditions of patients, and since it is impossible to know the thickness of the dental cord by naked eyes during use, there are problems in which use of the dental cord is troublesome and treatment is slow.

If hemostatic agent is applied to the cotton yarn, the cotton yarn may melt due to the hemostatic agent, and thus, it is not easy to apply the cotton yarn to the dental cord in practice.

The above information disclosed in this background section is only for enhancement of understanding of the background of the invention and therefore it may contain information that does not form the prior art that is already known in this country to a person of ordinary skill in the art.

### SUMMARY

Various aspects of the present invention provide a gingival retraction cord using microfiber which is free of lint and hemostatic agent penetrates well and is not melt even by hemostatic agent, and whose code is easily distinguished.

In an aspect of the invention, a gingival retraction cord using microfiber includes a microfiber cord, which is knitted with a plurality of microfiber strands, of 83 to 95 wt %, a dye of 0.01 to 0.10 wt % for dyeing the microfiber cord, and hemostatic agent of 4.99˜16.99 wt % which is soaked into the microfiber cord. A thickness of the microfiber cord is 0.45 to 1.35 mm. The microfine cord is classified into a green microfiber cord, a brown microfiber cord, a purple microfiber cord, a blue microfiber cord, and an orange microfiber cord, depending on thicknesses of the microfiber cords, and the microfiber cords are dyed by using dyes.

According to an exemplary embodiment of the invention, microfiber which his composed of finely split yarns and has a maximized surface area is applied to a gingival retraction cord using microfiber, and thus, hemostatic agent can be soaked into the microfiber as much as possible.

Therefore, hemostatic effects can be maximized.

In addition, a dental cord using microfiber according to the present invention is almost free of lint compared to a cotton yarn cord of related art, and thus, it is possible to increase penetration effects of hemostatic agent. In addition, the dental cord using microfiber according to the present invention does not require the existing singeing process for removing the lint, and thus, economic efficiency increases.

In addition, since colors are different from each other depending on thicknesses of the microfiber cord, a user can easily know a thickness of the dental cord, and thus, dental treatment can be performed conveniently.

In addition, a microfiber cord configured by nylon-6 and polyethylene terephthalic acid (PET) is coated with hemostatic agent, and thereby, the microfiber cord is not melt by the hemostatic agent. Accordingly, the microfiber cord is easily applied to the dental cord.

### BRIEF DESCRIPTION OF THE DRAWINGS

The above and other objects, features, and advantages of the present invention will be more apparent from the following detailed description in conjunction with the accompanying drawings, in which:

FIG. 1 is a photograph of a cotton yarn cord of related art for which a singeing process has not performed;

FIG. 2 is a photograph of a cotton yarn cord of related art for which the singeing process has performed;

FIG. 3 is a photograph of microfiber which is not split and is applied to a gingival retraction cord using microfiber according to the present invention;

FIG. 4 is a photograph in which the microfiber of FIG. 3 is split; and

FIGS. 5 to 8 are photographs of the gingival retraction cord using microfiber according to the present invention.

### DETAILED DESCRIPTION OF EXEMPLARY EMBODIMENTS

Hereinafter, exemplary embodiments of the present invention will be described in detail with reference to the accompanying drawings.

As illustrated in the following figures, a gingival retraction cord using microfiber according to the present invention is configured to include a microfiber cord of 83 to 95 wt % knitted with a plurality of microfiber strands, a dye of 0.01 to 0.10 wt % for dyeing the microfiber cord, and hemostatic agent of 4.99 to 16.99 wt % soaked into the microfiber cord dyed with the dye.

As described above, a configuration of the gingival retraction cord using the microfiber according to the present invention is derived from a test.

That is, as a result of the test, if the microfiber cord is less than 83 wt %, content of the hemostatic agent is 17 wt % or more, thereby, resulting in more hemostatic agent than necessary being soaked into the microfiber cord.

In other words, since the content of the hemostatic agent is 17 wt % or more, the hemostatic agent disappears from the cord during use of the cord, and thereby, there is inconvenience and economic efficiency decreases.

In addition, if the microfiber cord exceeds 95 wt %, the content of the hemostatic agent is less than 5 wt %. As a result, it is difficult to expect hemostatic effects due to lack of embedding (or impregnation) of the hemostatic agent in the microfiber cords.

Therefore, the gingival retraction cord using microfiber according to the present invention has no problem to use a cord containing the microfiber cord of 83 to 95 wt % and the hemostatic agent of 4.99 to 16.99 wt %, and is found to be the most economical and to have the best hemostatic effects.

In addition, the microfiber used as the cord is composed of nylon-6 and polyethylene terephthalic acid (PET), and a mixing ratio thereof is composed of the PET of 42 to 43 parts by weight to the nylon of 100 parts by weight.

In addition, the PET is configured to include a mixture (or polymer) of terephthalic acid (TPA) and ethylene glycol (EG), carbon, water, finish oil, and other addition agents.

The microfiber having the configuration is obtained by mixing the nylon-6 and the PET at the ratio described above and thinly extracting a thread from the mixture.

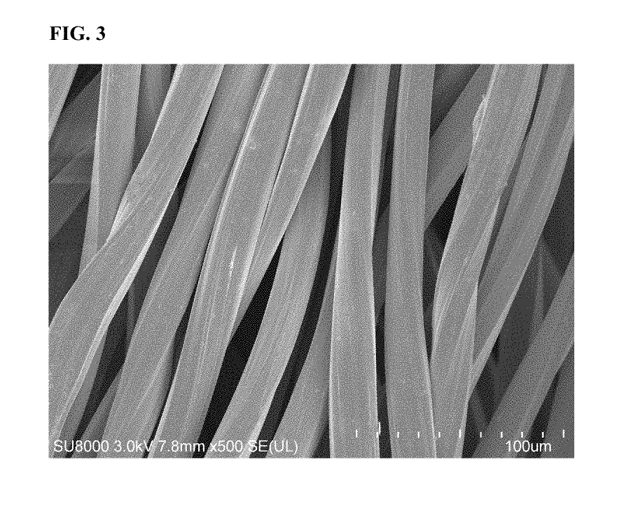

The thread extracted in this manner is illustrated in FIG. 3.

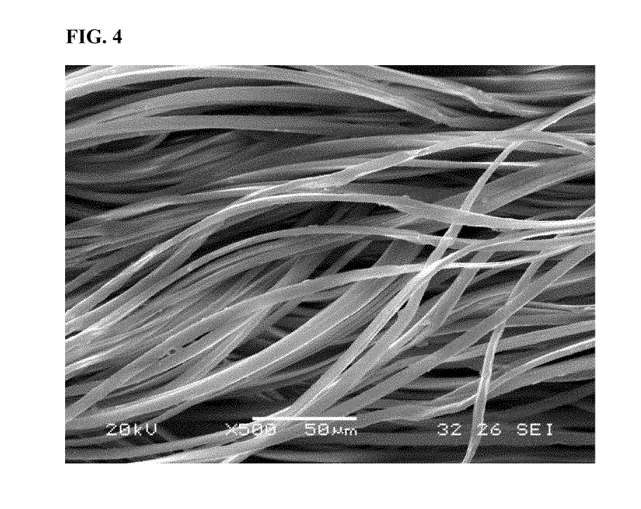

Thereafter, the thread of FIG. 3 is finely divided into eight parts so as to be thinner to produce the microfiber as illustrated in FIG. 4.

The microfiber produced by dividing the thin thread absorbs liquid (moisture and the like) well.

The reason for this is that, if fibers with the same area are produced as microfibers, surface areas thereof become much larger, and thereby, the microfibers can absorb more moisture.

Therefore, fabric made of microfiber has more absorbency than a natural fiber.

Particularly, since the microfiber is made so dense, stimulus thereof to the skin is very small, and thus, the microfiber is very suitable for a dental cord.

That is, the microfiber is excellent in absorbency and has very little skin stimulus due to a tightly formed structure.

The microfibers are knitted with multiple strands, and particularly, knitted with a thickness in the range of 0.45 to 1.35 mm, and thereby, the microfiber cord is manufactured.

In addition, the microfiber cord knitted in the above-mentioned range of thickness is dyed in one color of green, brown, purple, blue, or orange by using dyes.

The dyes of various colors are used for dyeing the microfiber cords, and gingival retraction cords using microfibers according to the present invention are respectively dyed by using dyes having different colors depending on thicknesses of the microfibers.

Specifically, in a case where the dye has a green color, the dye is applied to a microfiber cord having a thickness of 0.45 to 0.75 mm.

In a case of microfiber cords of green color, the microfiber cords are classified into a dark green microfiber cord and a light green microfiber, that is, thicknesses of the green microfiber cords can be divided into two types.

For example, the dark green microfiber cord is applied to a thickness of 0.45 to 0.65 mm, and the light green microfiber cord is applied to a thickness of 0.55 to 0.75 mm.

In addition, a brown dye is applied to the microfiber cord having a thickness of 0.65 to 0.85 mm.

In addition, a purple dye is applied to the microfiber cord having a thickness of 0.80 to 1.00 mm.

In addition, a blue dye is applied to the microfiber cord having a thickness of 1.00 to 1.20 mm.

In addition, an orange dye is applied to the microfiber cord having a thickness of 1.15 to 1.35 mm.

Thus, the green microfiber cord has a thickness of 0.45 to 0.75 mm.

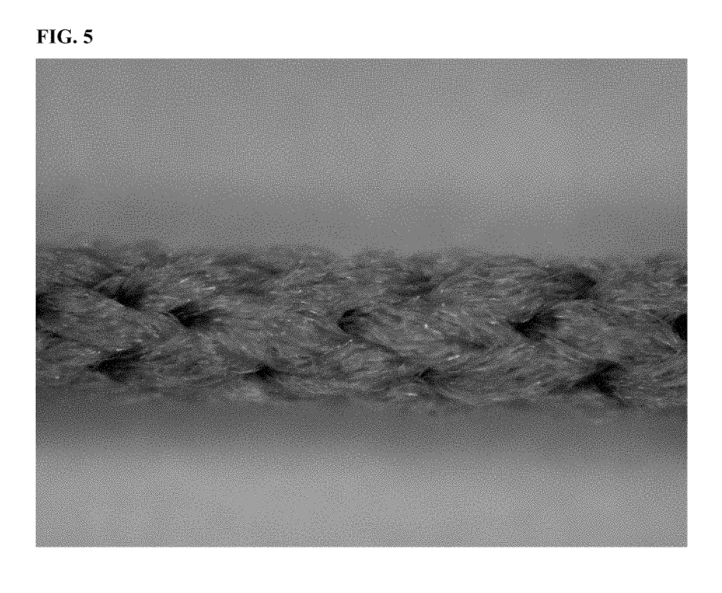

In addition, the brown microfiber cord has a thickness of 0.65 to 0.85 mm as illustrated in FIG. 5.

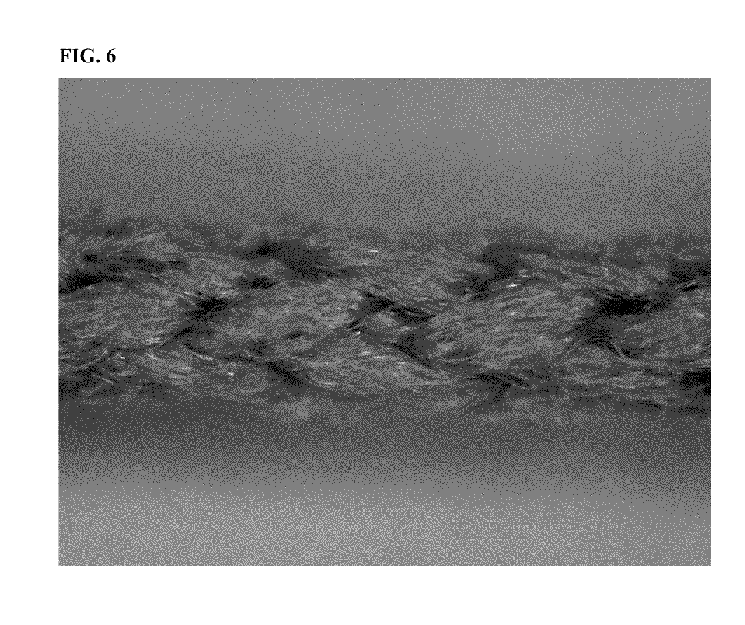

In addition, the purple microfiber cord has a thickness of 0.80 to 1.00 mm as illustrated in FIG. 6.

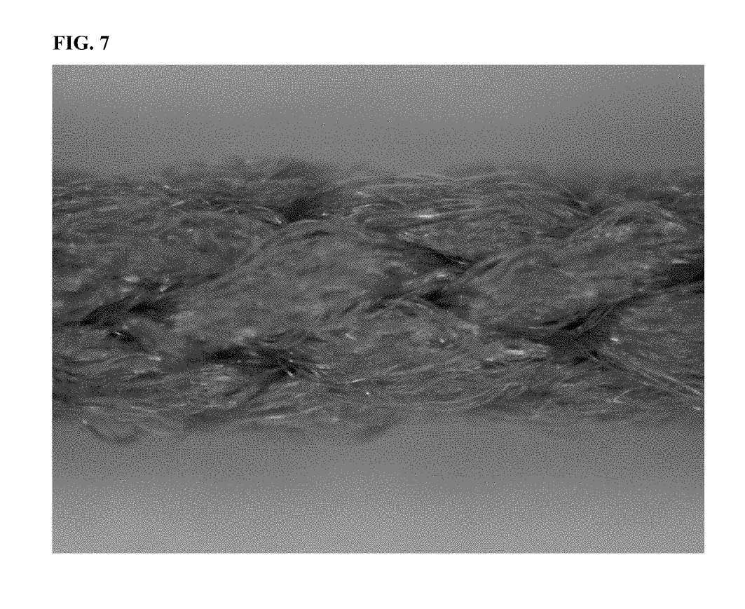

In addition, the blue microfiber cord has a thickness of 1.00 to 1.20 mm as illustrated in FIG. 7.

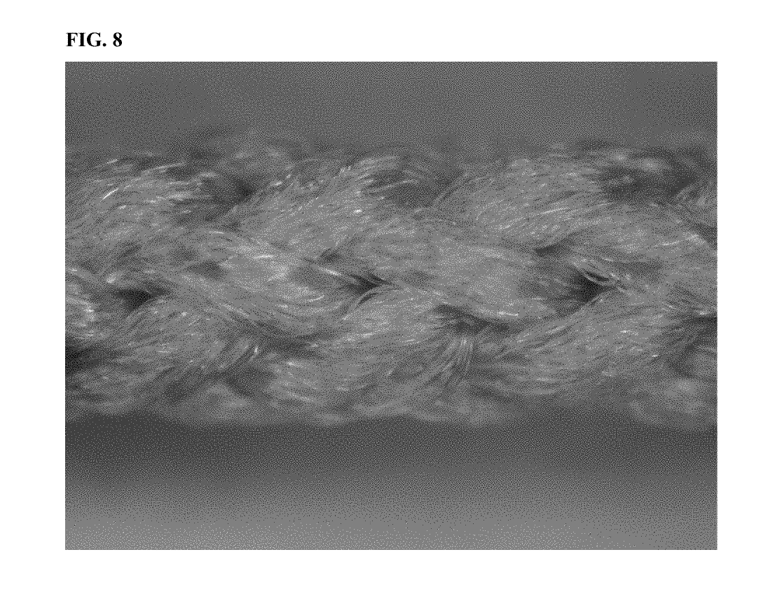

In addition, the orange microfiber cord has a thickness of 1.15 to 1.35 mm as illustrated in FIG. 8.

The microfiber cord dyed in this manner is allowed to absorb hemostatic agent having the above-mentioned content.

At this time, the hemostatic agent contains aluminum chloride hexahydrate solution (CAS 7784-13-6).

The aluminum chloride hexahydrate solution which is hemostatic agent is known to be safe for a human body and may be used for cosmetics or treatment of hyperhidrosis.

For example, an existing aluminum sulfate hemostatic agent has a side effect of decoloring the gum in black, and ab epinephrine hemostatic agent may also have a side effect to a patient with cardiovascular disease.

### First Example

First, a microfiber cord knitted with nylon-6 of 25.7 wt % and PET of 59.9 wt % is prepared.

Thereafter, the microfiber cord is dyed so as to have a brown color.

In addition, in order for the microfiber cord to be dyed in a brown color, a red dye (Synolon red SE) of 0.016 wt %, a blue dye (Synolon blue KRD) of 0.025 wt %, and a yellow dye (Synolon yellow) of 0.059 wt % are mixed with each other.

Then, a brown microfiber cord illustrated in FIG. 5 is manufactured.

Subsequently, aluminum chloride hexahydrate, which is hemostatic agent, of 14.3 wt % is soaked into a dyed brown microfiber cord to manufacture a brown dental cord.

### Second Example

First, a microfiber cord knitted with nylon-6 of 26.8 wt % and PET of 62.7 wt % is prepared.

Thereafter, the microfine cord is dyed with a purple dye (Synolon violet) of 0.1 wt %.

Then, a purple microfiber cord illustrated in FIG. 6 is manufactured.

Subsequently, aluminum chloride hexahydrate, which is hemostatic agent, of 10.4 wt % is soaked into a dyed purple microfiber cord to manufacture a purple dental cord.

### Third Example

A microfiber cord knitted with nylon-6 of 27.9 wt % and PET of 65.2 wt % is prepared.

In order for the prepared microfiber cord to be dyed in a blue color, a blue dye is added to perform dyeing.

At this time, the dye is obtained by mixing Synolon blue KRD of 0.042 wt and Synolon Turquoise blue of 0.058 wt %, which are two blue dyes, and dyeing is performed by using the dye.

Then, a blue microfiber cord illustrated in FIG. 7 is manufactured.

Subsequently, aluminum chloride hexahydrate, which is hemostatic agent, of 6.8 wt % is soaked into a dyed blue microfiber cord.

### Fourth Example

A microfiber cord knitted with nylon-6 of 28.4 wt % and PET of 66.4 wt % is prepared.

In order for the prepared microfiber cord to be dyed in an orange color, a red dye (Synolon red SE) of 0.022 wt % and a yellow dye (Synolon yellow SE) of 0.078 wt % are mixed with each other and dyeing is performed by using the mixed dye.

Then, a microfiber cord having an orange color illustrated in FIG. 8 is manufactured.

Subsequently, aluminum chloride hexahydrate, which is hemostatic agent, of 5.1 wt %, is soaked into a dyed orange microfiber cord.

### Fifth Example

A microfiber cord knitted with nylon-6 of 24.9 wt % and PET of 58.8 wt % is prepared.

In order for the prepared microfiber cord to be dyed in a green color, a red dye (Synolon red SE) of 0.010 wt %, a blue dye (Synolon blue KRD) of 0.062 wt %, and a yellow dye (Synolon yellow SE) of 0.028 wt % are mixed with each other, and dyeing is performed by using the mixed dye.

Then, while not illustrated in the figures, a green microfiber cord is manufactured.

Subsequently, aluminum chloride hexahydrate, which is hemostatic agent, of 16.2 wt % is soaked into the dyed green microfiber cord.

On the other hand, in the above First to Fifth Examples, the PET contains a polymer of TPA and EG of 98.7 wt %, carbon of 0.4 wt %, water of 0.2 wt %, finish oil of 0.6 wt %, and other additives of 0.1 wt %.

In First to Fifth Examples, contents of the microfiber cord, the dye, and the hemostatic agent differ depending on colors of the microfiber cords, because thicknesses of the microfiber cords are different from each other.

Therefore, in order to allow the dye and the hemostatic agent to penetrate the microfiber cord as desired, the above-mentioned mixing ratio has to be appropriately adjusted.

As described above, the dental cord using the microfiber is configured by divided threads as illustrated in FIG. 4, and thereby, a surface area of the thread is maximized.

Therefore, the hemostatic agent can be soaked into the microfiber as much as possible.

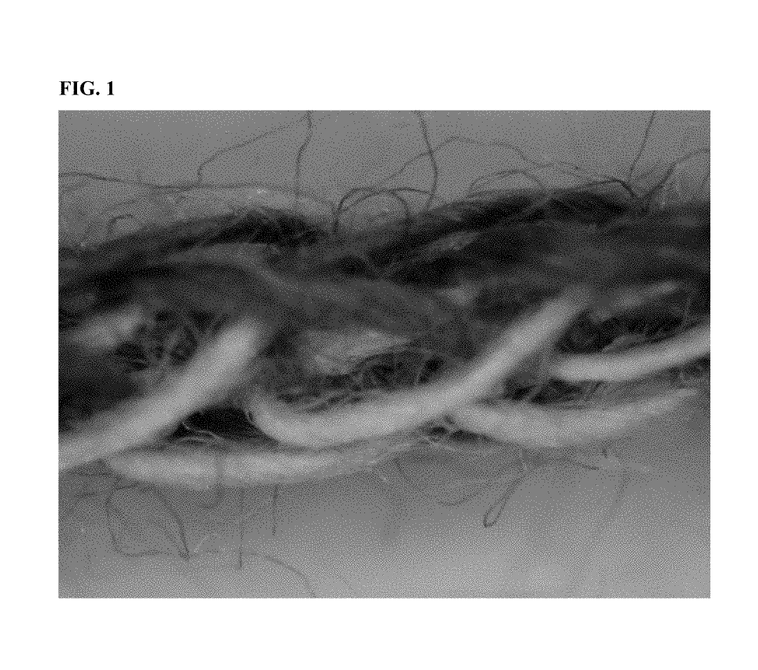

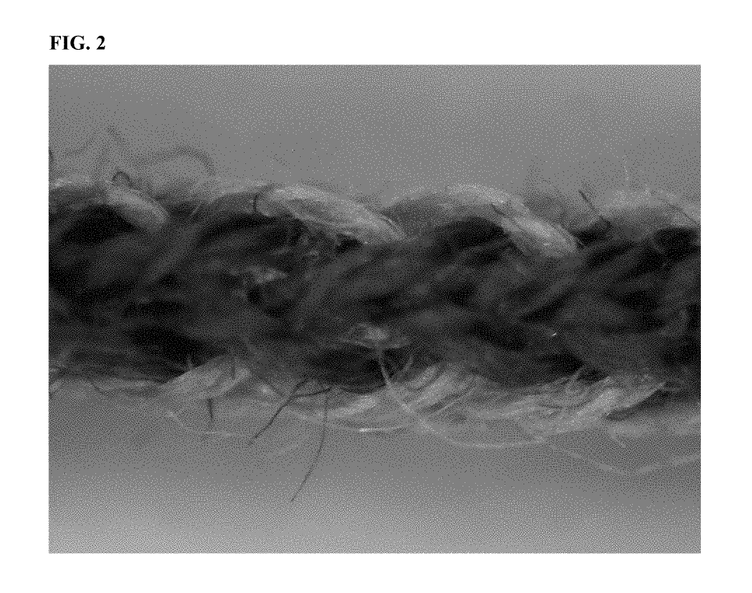

In addition, as illustrated in FIGS. 5 to 8, the gingival retraction cord is almost free of lint, compared to the dental cord (see FIGS. 1 and 2) which uses the existing cotton yarn.

In addition, since colors of the dental cords are different from each other depending on thicknesses of the microfibers, a user (dentist) can easily check the thickness of the dental cord, and thereby, the dental cord can be conveniently used without troubles in dental treatment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A gingival retraction cord using microfiber comprising:
a microfiber cord, which is knitted with a plurality of microfiber strands, of 83 to 95 wt %;
a dye of 0.01 to 0.10 wt % dyeing the microfiber cord; and
a hemostatic agent of 4.99˜16.99 wt % which is soaked into the microfiber cord,
wherein a thickness of the microfiber cord is 0.45 to 1.35 mm, and
wherein the microfine cord is classified into a green microfiber cord, a brown microfiber cord, a purple microfiber cord, a blue microfiber cord, and an orange microfiber cord, depending on thicknesses of the microfiber cords, and the microfiber cords are dyed by using dyes.

2. The gingival retraction cord using microfiber according to claim 1, wherein the hemostatic agent is configured to include aluminum chloride hexahydrate.

3. The gingival retraction cord using microfiber according to claim 1, wherein the green microfiber cord has a thickness of 0.45 to 0.75 mm.

4. The gingival retraction cord using microfiber according to claim 1, wherein the brown microfiber cord has a thickness of 0.65 to 0.85 mm.

5. The gingival retraction cord using microfiber according to claim 1, wherein the purple microfine cord has a thickness of 0.80 to 1.00 mm.

6. The gingival retraction cord using microfiber according to claim 1, wherein the blue microfine cord has a thickness of 1.00 to 1.20 mm.

7. The gingival retraction cord using microfiber according to claim 1, wherein the orange microfiber cord has a thickness of 1.15 to 1.35 mm.
